(19) United States
(12) Patent Application Publication
(10) Pub. No.: US 2006/0291985 A1
(43) Pub. Date: Dec. 28, 2006

(54) Lightweight device for conveniently attaching and transporting household waste receptacles behind automobiles

(76) Inventor: Bree O. Sullivan, Thomasville, GA (US)

Correspondence Address: Ralph A. Dowell of DOWELL & DOWELL P.C., 2111 Eisenhower Ave, Suite 406, Alexandria, VA, 22314, US

(21) Appl. No.: 11/447,889

(22) Filed: Jun. 7, 2006

Related U.S. Application Data
(60) Provisional application No. 60/695,197, filed on Jun. 28, 2005.

(51) Int. Cl. B60P 9/00

(52) U.S. Cl. 414/462

(57) ABSTRACT

A lightweight device that attaches a waste receptacle to a passenger vehicle so that the vehicle can easily tow the waste receptacle. The device includes first and second parallel spaced plastic bars that are connected, such as by a pair of adjustable, rugged nylon straps. The first bar includes a loop for attaching the device to an automotive hitch, and the second bar has at least one hook for grasping the waste receptacle. To use the device, the first bar is secured to the vehicle, and the at least one hook is attached to the waste receptacle so vehicle can easily tow the waste receptacle.

### CROSS-REFERENCE TO RELATED APPLICATIONS

This application claims the priority to U.S. Provisional Patent Application No. 60/695,197, entitled Lightweight Device for Conveniently Attaching and Transporting Household Waste Receptacles Behind Automobiles, filed Jun. 28, 2005, and is herein incorporated by reference in its entirety.

### BACKGROUND OF THE INVENTION

1. Field of the Invention

In general, the invention is directed to a device for attaching and transporting household waste receptacles. More specifically, the invention is directed to such a device for transporting and transporting household waste receptacles behind automobiles.

2. Brief Description of the Related Art

Many residents take advantage of waste collection services provided by waste disposal companies. These waste collection services typically require a resident to place waste receptacle(s) at a collection point on a particular day of the week so that the waste disposal company can collect the waste. This collection point is usually located proximate a road in front of a residence.

Since a resident has to maneuver his or her waste receptacle(s) between his or her residence and this collection point, most waste receptacles include wheels so as to allow the resident to more easily move his or her waste receptacle(s). Further, most waste receptacles have a hinged lid with one or more handles that enable a resident to tilt the receptacle onto its wheels. Thus, to move such a receptacle, a resident grasps a handle and tilts the receptacle onto its wheels so that the receptacle rolls along as the resident walks.

However, even in light of the integrated wheels and tiltable designs of conventional waste receptacles, the task of moving these receptacles to and from a collection point is still often difficult in rural areas. In these areas, a collection point is typically a considerable distance from a residence. These distances often include gravelly paths, muddy areas, and elevation changes. Further, these difficulties are magnified during inclement weather, such as rain, snow, and extreme temperatures.

To aid the task of transporting waste receptacles to and from collection points in rural areas, a resident can use a passenger vehicle, such as a car, van, or truck, to move the receptacles. However, most waste receptacles are oversized and therefore do not fit in most passenger vehicles. Even if a resident has a vehicle that does accommodate these large receptacles, it is very difficult to lift these large, heavy receptacles into the vehicle.

As a result of the problems associated with maneuvering large waste receptacles, a number of devices have been employed to overcome these problems. For example, US Patent Application Publication No. 2005/0023796 discloses a waste receptacle transport device that connects a waste receptacle to a vehicle so that the vehicle can tow the receptacle. The waste receptacle transport device comprises metal bars and a suction cup or a magnet for attaching the device to a vehicle. However, such a magnet or suction cup does not provide a secure attachment to the vehicle, especially if the surface of the vehicle to which the magnet or suction cup is attached has any contours or irregularities. As a result, the transport device and the receptacle may easily become disconnected from the vehicle. Further, such a magnet or suction cup may scratch or otherwise damage the surface of the vehicle.

Alternatively, US Patent Application Publication No. 2004/0164517 discloses a trash can trolley that connects a waste receptacle to a hitch of a vehicle so that the vehicle can tow the receptacle. The trolley consists of six metal pieces that are welded together to form a unitary structure. However, this trolley requires a hitch and is therefore unsuitable for many passenger vehicles.

While the prior art may provide a solution to the problems associated with maneuvering large waste receptacles, these solutions suffer from significant drawbacks. For instance, the prior art devices for transporting these receptacles are made of metal and are thus heavy and cumbersome to install. Further, they require oiling and are subject to rusting. Thus, there exists a need for a lightweight, maintenance-free device that conveniently attaches a waste receptacle to any passenger vehicle so that the vehicle can tow the receptacle, without requiring magnets, suction cups, and/or a hitch.

### SUMMARY OF THE INVENTION

The present invention is directed to a lightweight device that conveniently attaches a waste receptacle to a passenger vehicle so that the vehicle can easily tow the waste receptacle. In a preferred embodiment, the device comprises first and second parallel spaced plastic bars that are connected on either end by a pair of adjustable, rugged nylon straps. The first bar includes a loop for securing the device to an automobile hitch, and the second bar has a pair of hooks for grasping a handle of the waste receptacle.

To use the device, the first bar is placed in the vehicle's rear compartment, such as trunk, rear cargo area, or truck bed. A rear compartment door is then closed over the nylon straps to secure the device to the vehicle. The hooks on the second bar are then attached to the handle of the waste receptacle. As the vehicle moves forward, the waste receptacle is tilted onto its wheels so that it can easily roll behind the vehicle.

As a result, the present invention provides a universal, adjustable design that can be used with any passenger vehicle, without requiring magnets, suction cups, or hitches. Further, since the invention is made from non-metallic materials, it is lightweight, rust-proof, and does not require maintenance, such as oiling.

### BRIEF DESCRIPTION OF THE DRAWINGS

FIG. 1 is a prospective view of the device for attaching and transporting waste receptacles of the present invention.

FIG. 2 is a top illustrational view showing the device attached to an automobile.

FIG. 3. is a side illustrational view showing the device attached to both an automobile and to a waste receptacle.

FIG. 4. is a side illustrational view showing the device attached to a sport utility vehicle (SUV).

FIG. 5. is a side illustrational view showing the device attached to a truck.

FIG. 6. is side view showing a strap received into a slot of a bar of the present invention.

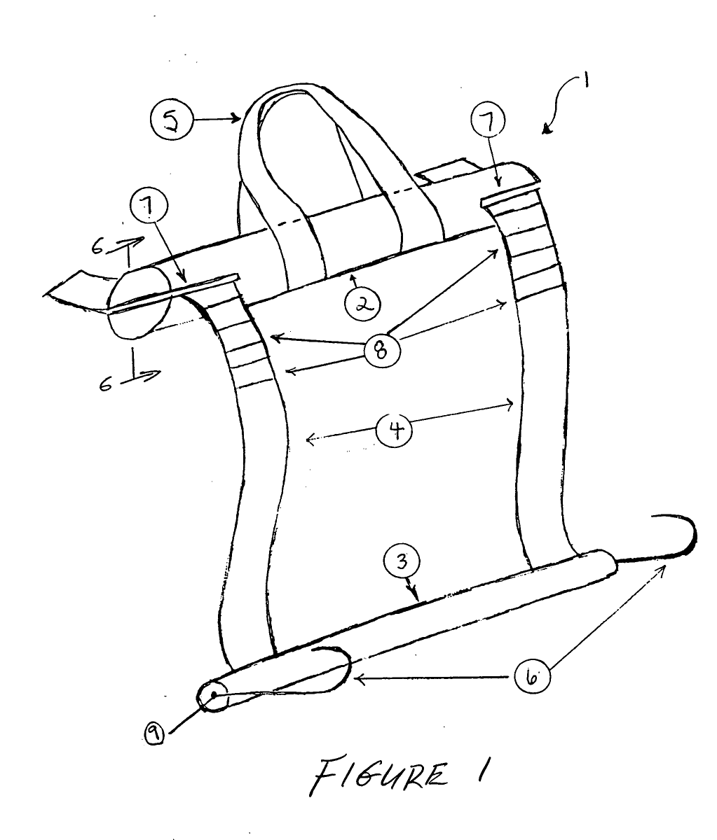

### DETAILED DESCRIPTION

A lightweight device 1 for conveniently attaching and transporting household waste receptacles behind automobiles comprises a first bar 2, a second bar 3, and a connecting means, such as a pair of spaced straps 4, that is secured to both the first and second bars 2 and 3, respectively, to maintain the bars 2 and 3 in a substantially parallel relationship. In a preferred embodiment, a loop 5 is mounted to the first bar 2, and a pair of hooks 6 are mounted to the second bar 3.

The first and second bars 2 and 3, respectively, are generally circular in cross-section and have a diameter of approximately 1 in. The bars 2 and 3 are approximately 12 in. in length and are preferably constructed from a lightweight, rigid, durable, plastic material, such as polyvinyl chloride (PVC) piping. Further, the first bar 2 includes a pair of slots 7. Each slot 7 begins on each end of the first bar 2 and extends inwardly along a longitudinal axis A-A for approximately 1.5 in. Further, each slot 7 has a thickness of approximately 1/16 in.

The straps 4 are received in the slots 7. The straps 4 are each approximately 36 in. in length and are preferably made from a rugged, durable material, such as nylon. The straps 4 also include a series of spaced ridges 8, wherein each ridge 8 extends across width of each strap 4. In a preferred embodiment, the series of ridges 8 extends along the entire length of the straps 4.

The ridges 8 have a height that is greater than the thickness of the slots 7, as shown in FIG. 6. Thus, the ridges 8 allow the straps 4 to be securely received in the slots 7 of the bars 2 and 3 and prevent any accidental displacement of the straps 4 from the slots 7. Moreover, since the ridges 8 are located along the length of the straps 4, the distance between the first and second bars 2 and 3, respectively, can be easily adjusted.

The first bar 2 includes a securing means, such as a loop 5 for securing the device 1 to a hitch of an automobile. The strap is mounted between the slots 7 so that it is substantially centered on the first bar 2. Like the straps 4, the loop 5 is preferably made from a durable flexible material, such as nylon, leather, or vinyl. Further, the loop 5 is approximately 1 in. in thickness and is of sufficient circumference to fit around a conventional vehicle hitch.

The second bar 3 includes an attachment means, such as a pair of hooks 6, for attaching the device 1 to a waste receptacle. The hooks 6 are mounted at 135° angles to the ends of the second bar 3. Preferably, the device 1 includes means for pivotally mounting the hooks 6 on the second bar 3, such as pins 9. The hooks 6 are approximately 2-3 in. in length and are preferably made from a durable plastic material.

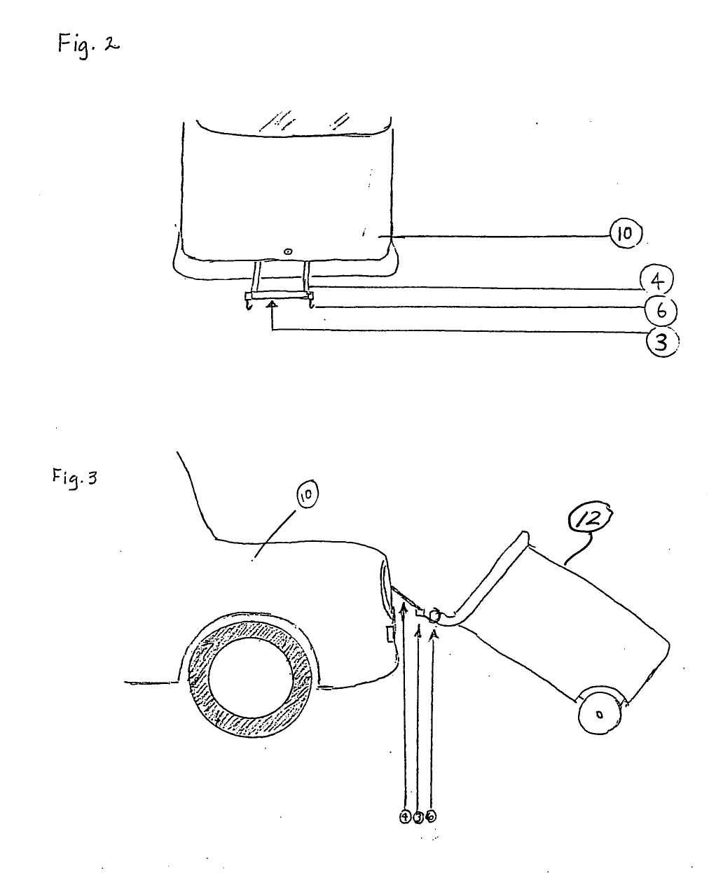

To use the device 1, the device 1 is first secured to a passenger vehicle 10 by placing the first bar 2 inside a rear compartment of the vehicle 10. The rear compartment is closed over the straps 4 so that the second bar 3 remains outside of the vehicle 10. If the passenger vehicle 10 is an automobile, namely a car, as shown in FIG. 2, then the first bar 2 is placed inside a trunk.

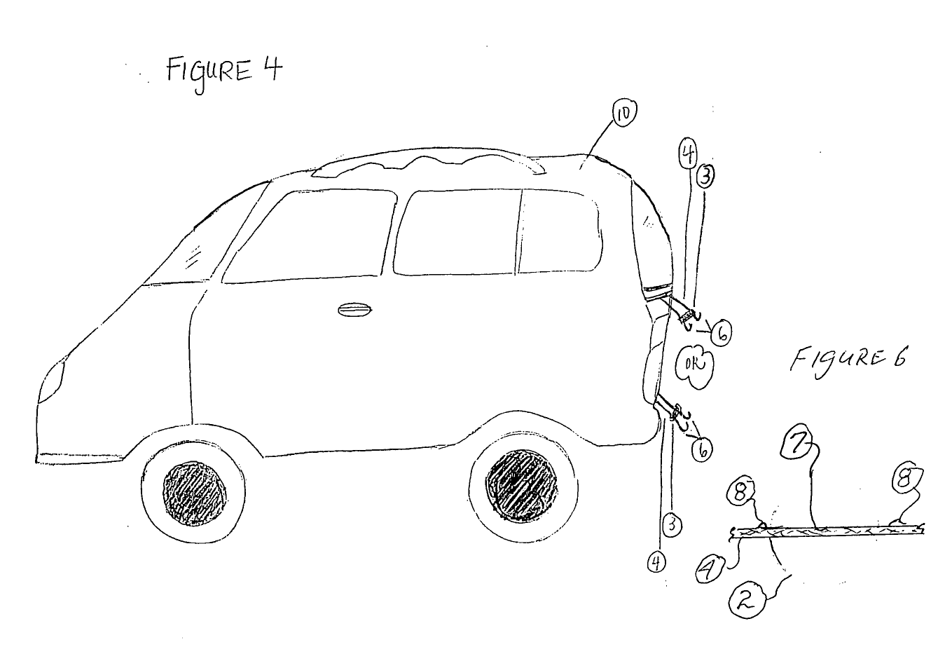

If the vehicle 10 is a sport utility vehicle (SUV), then the first bar 2 is placed a rear cargo area, as shown in FIG. 4. A door of the rear cargo area is closed over the straps 4 so that the device 1 is secured near the bottom of the vehicle 10. Alternatively, a rear window can be closed over the straps 4 so that the device 1 is secured higher on the vehicle 10.

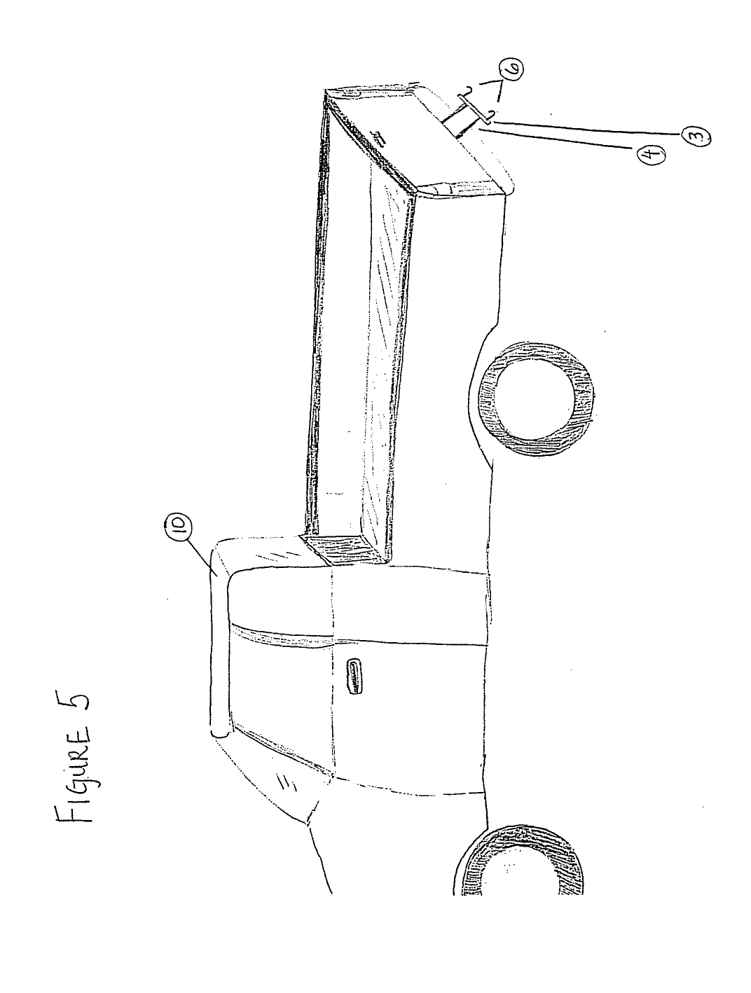

If the vehicle 10 is a truck, as shown in FIG. 5, then the first bar 2 is placed in a truck bed. The a tailgate is closed over the straps 4 so that the second bar 3 remains outside the truck. In addition to securing the device 1 to a vehicle 10 by placing the first bar 2 in the rear compartment, the device 1 can also be secured to a vehicle 10 by placing the loop 5 around a hitch mounted to the vehicle 10.

After being secured to the vehicle 10, the device 1 is then attached to a waste receptacle 12. The pair of hooks 6 on the second bar 3 attach to the waste receptacle 12, such as by grasping a handle, lip, or edge of the receptacle 12. Further, the length of the straps 4 can be adjusted to ensure the proper distance between the vehicle 10 and the waste receptacle 12.

Once the waste receptacle 12 is secured to the vehicle 10 via the device 1, the vehicle 10 can easily tow the receptacle 12. Since the hooks 6 are mounted at a 135° angle relative to the second bar 3, any forward movement of the vehicle 10 causes the receptacle to be tilted onto its wheels so it can easily roll behind the vehicle 10. When the vehicle 10 stops moving forward, the waste receptacle 12 is returned to its original, stationary position.

After use, the device 1 is removed from the waste receptacle 12 by detaching the hooks 6. The device 1 is then removed from the vehicle 10 by opening the rear compartment door and removing the first bar 2 from the rear compartment. If the vehicle 10 is a car, then the first bar 2 is removed from the trunk. If the vehicle 10 is an SUV, then the door of the rear cargo area is opened to remove the first bar 2 from the rear cargo area. Alternatively, window of the rear cargo area is opened to remove the first bar 2 from the rear cargo area. Lastly, if the vehicle 10 is a truck, then the first bar is removed from the truck bed by opening the tailgate. Alternatively, if the device 1 was attached to the hitch of the vehicle 10, the device 1 can be removed from the vehicle 10 by lifting the loop 5 from the hitch.

When the device 1 is not being used, its compact design makes it very easy and convenient to compactly store. Moreover, since the first and second bars 2 and 3, respectively, the straps 4, and the hooks 6 are all made from non-metallic materials, the device 1 is lightweight, rust-proof, and does not require maintenance, such as oiling.

The foregoing description of the present invention has been presented to illustrate the principles of the invention and not to limit the invention to the particular embodiments illustrated. It is intended that the scope of the invention be defined by all of the embodiments encompassed within the following claims and their equivalents.

I claim:

1. An apparatus for attaching and transporting household waste receptacles mounted on wheels to a vehicle, comprising:
a first bar;
a second bar;
a connecting means connecting the first and second bars in a spaced and generally parallel relationship with respect to one another; and
at least one attaching means mounted to the second bar for selectively attaching to a household waste receptacle mounted on wheels.

2. The apparatus of claim 1, wherein the at least one attaching means is at least one hook.

3. The apparatus of claim 2, wherein the at least one attaching means includes a pair of hooks mounted in spaced relationship to the second bar.

4. The apparatus of claim 3, wherein the connecting means includes a pair of spaced straps that are secured to both the first and second bars and maintain the bars in a substantially parallel relationship.

5. The apparatus of claim 4, wherein at least one of the first and second bars includes a pair of spaced slots therein, and each of the slots being of a size to receive one of the straps therein.

6. The apparatus of claim 5, wherein each strap includes at least one ridge of a size to prevent withdrawal of the straps in a direction toward the other of the first and second bars.

7. The apparatus of claim 6, wherein each strap includes a plurality of spaced ridges that permit relative adjustment of a length of the strap between the first and second bars.

8. The apparatus of claim 7, further comprising a loop mounted to the first bar.

9. The apparatus of claim 3, further comprising means for pivotally connecting the pair of hooks to the second bar.

10. The apparatus of claim 9, wherein the connecting means includes a pair of spaced straps that are secured to both the first and second bars and maintain the bars in a substantially parallel relationship.

11. The apparatus of claim 10, wherein at least one of the first and second bars includes a pair of spaced slots therein, and each of the slots being of a size to receive one of the straps therein.

12. The apparatus of claim 11, wherein each strap includes at least one ridge of a size to prevent withdrawal of the straps in a direction toward the other of the first and second bars.

13. The apparatus of claim 12, wherein each of the straps includes a plurality of spaced ridges that permit relative adjustment of a length of the pair of straps between the first and second bars.

14. The apparatus of claim 13, further comprising a loop mounted to the first bar.

15. The apparatus of claim 1, wherein the connecting means includes a pair of spaced straps that are secured to both the first and second bars and maintain the bars in a substantially parallel relationship.

16. The apparatus of claim 15, wherein at least one of the first and second bars includes a pair of spaced slots therein, and each of the slots being of a size to receive one of the straps therein.

17. The apparatus of claim 16, wherein each strap includes at least one ridge of a size to prevent withdrawal of the straps in a direction toward the other of the first and second rods.

18. The apparatus of claim 17, wherein each strap includes a plurality of spaced ridges that permit relative adjustment of a length of the strap between the first and second bars.

19. The apparatus of claim 18, further comprising a loop mounted to the first bar.
